(19) United States
(12) Patent Application Publication
(10) Pub. No.: US 2025/0296809 A1
(43) Pub. Date: Sep. 25, 2025

(54) EVACUATION IN AN ELEVATOR SYSTEM

(71) Applicant: KONE CORPORATION, Helsinki (FI)

(72) Inventors: Ari Jussila, Helsinki (FI); Toni Hirvonen, Helsinki (FI); Atso Koskinen, Helsinki (FI)

(73) Assignee: KONE CORPORATION, Helsinki (FI)

(21) Appl. No.: 19/233,634

(22) Filed: Jun. 10, 2025

Related U.S. Application Data
(63) Continuation of application No. PCT/EP2023/050166, filed on Jan. 5, 2023.

(51) Int. Cl. B66B 5/02

(52) U.S. Cl. CPC B66B 5/027

(57) ABSTRACT

According to an aspect, there is provided a solution in which an event requiring a stop to a next possible floor is detected for a moving elevator car. The stop is then selected to the next possible floor, the next possible floor being the closest unlocked floor in the moving direction of the elevator car.

### TECHNICAL FIELD

Various example embodiments generally relate to the field of elevator systems. In particular, some example embodiments relate to a solution for operating an elevator car in an evacuation situation.

### BACKGROUND

An elevator system comprises a safety system that, for example, may detect faults in the elevator system and initiate predetermined actions in response to the faults. An occurring fault detected by the safety system may, for example, require an immediate slowdown to a next possible floor or a stop at the next possible floor. However, it is possible that the next floor where the slowdown can be performed is locked or that it becomes locked after the elevator system has already made the decision to stop to that floor. The locked floor may be caused by various reasons, for example, there may be a fire protection door at a landing preventing opening of the door at the landing.

If the elevator system causes an elevator car to stop on the landing due to a fault detected by the safety system, the elevator car doors cannot be opened due to the locked doors. Thus, the fault prevents moving the elevator car away from the locked floor and, at the same time, the elevator car becomes trapped at the locked floor. If there are passengers in the elevator car, their safety may be in danger.

### SUMMARY

According to a first aspect, there is provided a method for operating an elevator car. The method comprises detecting an event requiring a stop to a next possible floor for a moving elevator car; and selecting to stop at the next possible floor, the next possible floor being the closest unlocked floor in the moving direction of the elevator car.

In an implementation form of the first aspect, the method further comprises detecting that a selected next possible floor becomes locked before stopping at the selected next possible floor; stopping the elevator car at the locked selected next possible floor; and allowing the elevator car to start travelling towards a new unlocked next possible floor.

In an implementation form of the first aspect, the method further comprises allowing the elevator car to pass at least one locked floor before stopping at the selected next possible floor.

In an implementation form of the first aspect, the method further comprises taking the elevator car out of use after stopping at the selected next possible floor.

According to a second aspect, there is provided an elevator system for operating an elevator car. The elevator system comprises means for detecting an event requiring a stop to a next possible floor for a moving elevator car; and means for selecting to stop at the next possible floor, the next possible floor being the closest unlocked floor in the moving direction of the elevator car.

In an implementation form of the second aspect, the elevator system further comprises means for detecting a that selected next possible floor becomes locked before stopping at the selected next possible floor; means for stopping the elevator car at the locked selected next possible floor; and means for allowing the elevator car to start travelling towards a new unlocked next possible floor.

In an implementation form of the second aspect, the elevator system further comprises means for allowing the elevator car to pass at least one locked floor before stopping at the next possible floor.

In an implementation form of the second aspect, the elevator system further comprises means for taking the elevator car out of use after stopping at the selected next possible floor.

According to a third aspect, there is provided an apparatus comprising at least one processor and at least one memory storing instructions that, when executed by the at least one processor, cause the apparatus to at least perform: detecting an event requiring a stop to a next possible floor for a moving elevator car; and selecting to stop at the next possible floor, the next possible floor being the closest unlocked floor in the moving direction of the elevator car.

According to a fourth aspect, there is provided a computer program comprising instructions which, when the program is executed by at least one processor, cause an apparatus to perform the method of the first aspect.

According to a fifth aspect, there is provided a computer-readable medium comprising a computer program comprising instructions which, when the program is executed by at least one processor, cause an apparatus to perform the method of the first aspect.

### BRIEF DESCRIPTION OF THE DRAWINGS

The accompanying drawings, which are included to provide a further understanding of the invention and constitute a part of this specification, illustrate embodiments of the invention and together with the description help to explain the principles of the invention. In the drawings:

FIG. 1 illustrates a method according to an example embodiment.

FIG. 2 illustrates an elevator system according to an example embodiment.

FIG. 3A illustrates an elevator car moving in an elevator shaft according to an example embodiment.

FIG. 3B illustrates an elevator car moving in an elevator shaft according to another example embodiment.

FIG. 4 illustrates an apparatus according to an example embodiment.

### DETAILED DESCRIPTION

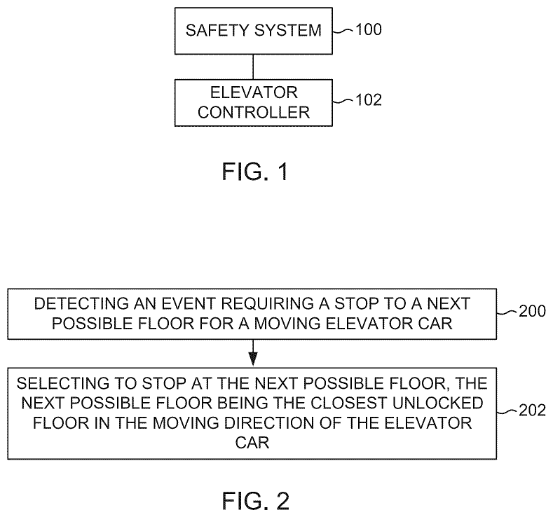

FIG. 1 illustrates an elevator system according to an example embodiment. The elevator system comprises an elevator controller 102 configured to control a drive. The drive may control a motor that then moves an elevator car in an elevator shaft. The elevator system further comprises a safety system 100 connected to the elevator controller 102. The safety system 100 may be configured to control safety issues relating to the elevator car. For example, the safety system 100 may be configured to detect, for a moving elevator car, an event requiring a stop to a next possible floor and request a stop to the next possible floor. The elevator controller 102 may be configured to receive the request from the safety system and select to stop at the next possible floor, the next possible floor being the closest unlocked floor in the moving direction of the elevator car.

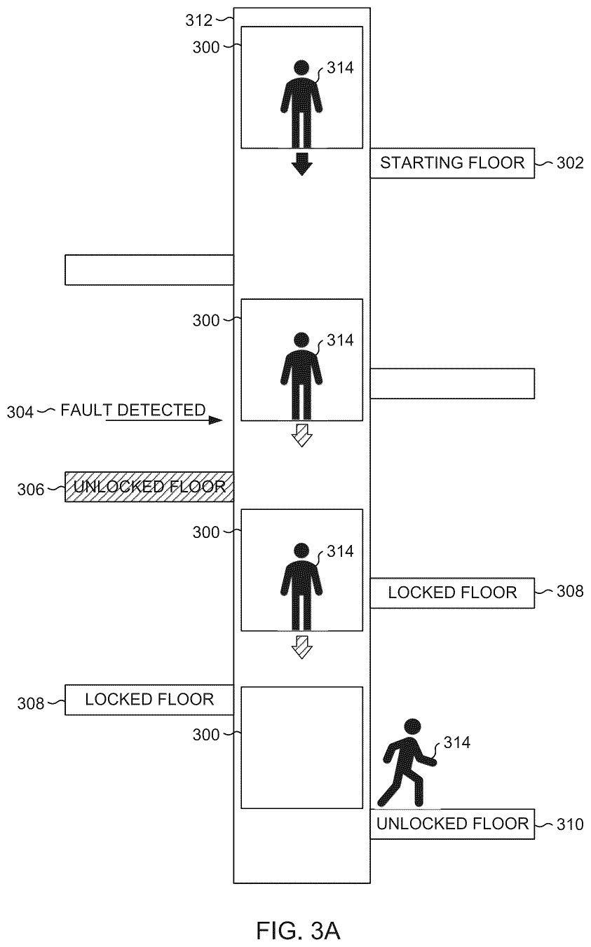

FIG. 2 illustrates a flow diagram of a method according to an example embodiment.

At 200 an event requiring a stop to a next possible floor may be detected for a moving elevator car. The detection may be performed, for example, by a safety system associated with an elevator system. The stop may be, for example, an emergency stop, an evacuation stop or any other event-based or ad-hoc destination.

At 202 a stop at the next possible floor may be selected, the next possible floor being the closest unlocked floor in the moving direction of the elevator car. The stop may be performed, for example, by an elevator controller in response to a stop request from the safety system.

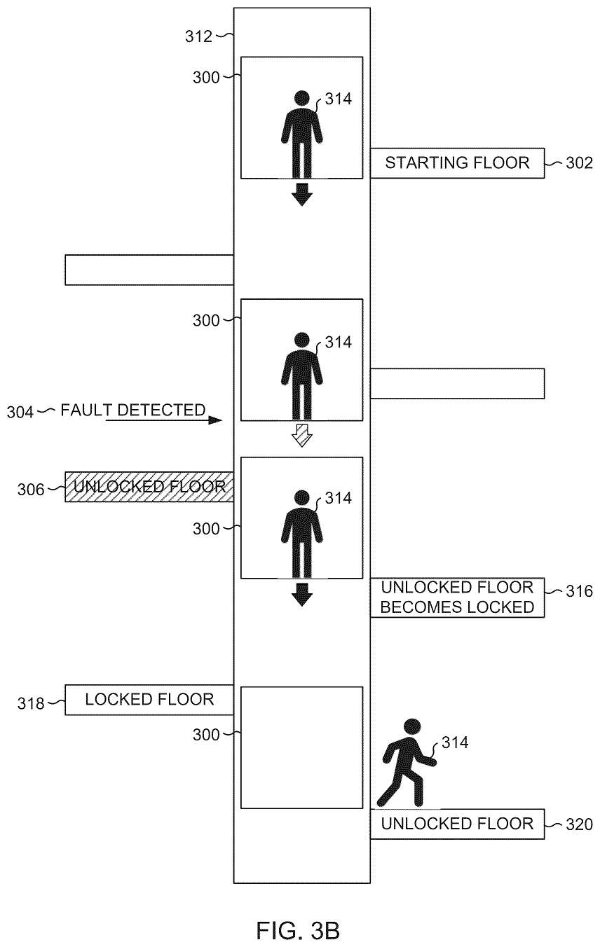

FIG. 3A illustrates an elevator car moving in an elevator shaft 312 according to an example embodiment. In this example embodiment, the elevator car 300 starts from a top floor 302 and accelerates from the top floor downwards. At some point before reaching a destination floor, a fault 304 may be detected. The fault may be of a type that requires an immediate slowdown or a stop to a next possible floor in the moving direction of the elevator car. The fault 304 may be detected, for example, with a safety system associated with the elevator system. An unlocked floor 306 could be regarded as the next possible floor, but it is not possible to stop at this floor because it is too close. After this, the elevator car 300 may be controlled to stop at a floor 308. This floor, however, is locked. The term “locked floor” refers generally to a floor at which the elevator car cannot stop. If the elevator car 300 stopped at this floor, it might not be possible to start the elevator again due to the detected fault, and a passenger 314 in the elevator car 300 could become trapped in the elevator car 300. In order to prevent this, the safety system may be configured to allow the elevator car 300 to pass at least one locked floor 308 during the slowdown and the elevator car eventually stops at the next possible floor, i.e. an unlocked floor 310. At the unlocked floor 310, the elevator car doors can be opened and the passenger(s) 314 can be evacuated from the elevator car 300. In an example embodiment, the elevator car 300 may be taken out of use after it has stopped to the evacuation floor (i.e. the unlocked floor 310) and the elevator doors have been detected to open.

FIG. 3B illustrates an elevator car moving in an elevator shaft 312 according to another example embodiment. In this example embodiment, the elevator car 300 starts from a top floor 302 and accelerates from the top floor downwards. At some point before reaching a destination floor, a fault 304 may be detected. The fault may be of a type that requires an immediate slowdown or a stop to a next possible floor in the moving direction of the elevator car. The fault 304 may be detected, for example, with a safety system associated with the elevator system. An unlocked floor 306 could be regarded as the next possible floor, but it is not possible to stop at this floor because it is too close. After this, the elevator car 300 may be controlled to stop at an unlocked floor 316. However, it may happen that after making the selection to stop at the floor 316 and starting the slowdown process to the floor 316, the floor 316 may become locked. This may be caused, for example, by a fire protection door at the floor 316. As it may not be possible to stop the slowdown to the floor 316, the elevator car 300 may still be driven and stopped at the locked floor 316. If the elevator car 300 stopped permanently at this floor, a passenger 314 in the elevator car 300 could become trapped in the elevator car 300. In order to prevent this, the safety system may be configured to allow the elevator car 300 to start travelling towards a new, unlocked next possible floor 320 and pass also the locked floor 318. At the floor 320, the elevator car doors can be opened and the passenger(s) 314 can be evacuated from the elevator car 300. In an example embodiment, the elevator car 300 may be taken out of use after it has stopped to the evacuation floor (i.e. the unlocked floor 320) and the elevator doors have been detected to open.

In an example embodiment, an evacuation run attempt count from a locked floor can be parametrized. The safety system may be configured to allow at least one evacuation run start from the locked floor.

At least one of the examples and embodiments disclosed above may enable a solution in which evacuation with an elevator car can be performed without the risk of a passenger or passengers being trapped in the elevator car at a locked floor.

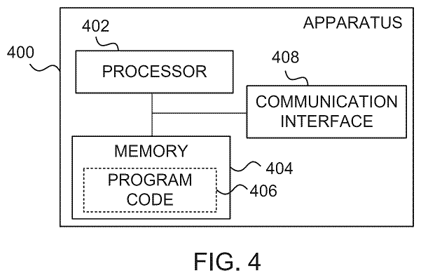

FIG. 4 illustrates a block diagram of an apparatus 400 according to an example embodiment. In an example embodiment, the apparatus 400 may implement functions of an elevator controller or a safety controller. The apparatus 400 may comprise one or more processors 402, and one or more memories 404 that comprise computer program code 406. The apparatus 400 may also comprise a communication interface 408 for wired and/or wireless communication. Although the apparatus 400 is depicted to include only one processor 402, the apparatus 400 may include more than one processor. In an example embodiment, the memory 404 is capable of storing instructions, such as an operating system and/or various applications.

Furthermore, the processor 402 is capable of executing the stored instructions. In an example embodiment, the processor 402 may be embodied as a multi-core processor, a single core processor, or a combination of one or more multi-core processors and one or more single core processors. For example, the processor 402 may be embodied as one or more of various processing devices, such as a coprocessor, a microprocessor, a controller, a digital signal processor (DSP), a processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, or the like. In an example embodiment, the processor 402 may be configured to execute hard-coded functionality. In an example embodiment, the processor 402 is embodied as an executor of software instructions, wherein the instructions may specifically configure the processor 402 to perform the algorithms and/or operations described herein when the instructions are executed, for example, the steps discussed relating to FIG. 2.

The memory 404 may be embodied as one or more volatile memory devices, one or more non-volatile memory devices, and/or a combination of one or more volatile memory devices and non-volatile memory devices. For example, the memory 404 may be embodied as semiconductor memories (such as mask ROM, PROM (programmable ROM), EPROM (erasable PROM), flash ROM, RAM (random access memory), etc.).

In an embodiment, the at least one memory 404 may store program instructions 406 that, when executed by the at least one processor 402, cause the apparatus 400 to perform the functionality of the various embodiments discussed herein. Further, in an embodiment, at least one of the processor 402 and the memory 404 may constitute means for implementing the discussed functionality. In an example embodiment, at least one of the processor 402 and the memory 404 may constitute means for detecting an event requiring a stop to a next possible floor for a moving elevator car, and means for selecting to stop at the next possible floor, the next possible floor being the closest unlocked floor in the moving direction of the elevator car.

Example embodiments may be implemented in software, hardware, application logic or a combination of software, hardware and application logic. The example embodiments can store information relating to various methods described herein. This information can be stored in one or more memories, such as a hard disk, a solid state drive, an optical disk, a magneto-optical disk, an RAM, and the like. One or more databases can store the information used to implement the example embodiments. The databases can be organized using data structures (e.g., records, tables, arrays, fields, graphs, trees, lists, and the like) included in one or more memories or storage devices listed herein. The methods described with respect to the example embodiments can include appropriate data structures for storing data collected and/or generated by the methods of the devices and subsystems of the example embodiments in one or more databases.

The components of the example embodiments may include computer readable medium or memories for holding instructions programmed according to the teachings and for holding data structures, tables, records, and/or other data described herein. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer. A computer-readable medium may include a computer-readable storage medium that may be any media or means that can contain or store the instructions for use by or in connection with an instruction execution system, apparatus, or device, such as a computer. A computer readable medium can include any suitable medium that participates in providing instructions to a processor for execution. Such a medium can take many forms, including but not limited to, non-volatile media, volatile media, transmission media, and the like.

While there have been shown and described and pointed out fundamental novel features as applied to preferred embodiments thereof, it will be understood that various omissions and substitutions and changes in the form and details of the devices and methods described may be made by those skilled in the art without departing from the spirit of the disclosure. For example, it is expressly intended that all combinations of those elements and/or method steps which perform substantially the same function in substantially the same way to achieve the same results are within the scope of the disclosure. Moreover, it should be recognized that structures and/or elements and/or method steps shown and/or described in connection with any disclosed form or embodiments may be incorporated in any other disclosed or described or suggested form or embodiment as a general matter of design choice. Furthermore, in the claims means-plus-function clauses are intended to cover the structures described herein as performing the recited function and not only structural equivalents, but also equivalent structures.

The applicant hereby discloses in isolation each individual feature described herein and any combination of two or more such features, to the extent that such features or combinations are capable of being carried out based on the present specification as a whole, in the light of the common general knowledge of a person skilled in the art, irrespective of whether such features or combinations of features solve any problems disclosed herein, and without limitation to the scope of the claims. The applicant indicates that the disclosed aspects/embodiments may consist of any such individual feature or combination of features. In view of the foregoing description it will be evident to a person skilled in the art that various modifications may be made within the scope of the disclosure.

1. A method for operating an elevator car, the method comprising:
detecting an event requiring a stop to a next possible floor for a moving elevator car; and
selecting to stop at the next possible floor, the next possible floor being the closest unlocked floor in the moving direction of the elevator car.

2. The method according to claim 1, further comprising:
detecting that a selected next possible floor becomes locked before stopping at the selected next possible floor;
stopping the elevator car at the locked selected next possible floor; and
allowing the elevator car to start travelling towards a new unlocked next possible floor.

3. The method according to claim 1, further comprising:
allowing the elevator car to pass at least one locked floor before stopping at the selected next possible floor.

4. The method according to claim 1, further comprising:
taking the elevator car out of use after stopping at the selected next possible floor.

5. An elevator system for operating an elevator car, the elevator system comprising:
means for detecting an event requiring a stop to a next possible floor for a moving elevator car; and
means for selecting to stop at the next possible floor, the next possible floor being the closest unlocked floor in the moving direction of the elevator car.

6. The elevator system according to claim 5, further comprising:
means for detecting that a selected next possible floor becomes locked before stopping at the selected next possible floor;
means for stopping the elevator car at the locked selected next possible floor; and
means for allowing the elevator car to start travelling towards a new unlocked next possible floor.

7. The elevator system according to claim 5, further comprising:
means for allowing the elevator car to pass at least one locked floor before stopping at the next possible floor.

8. The elevator system according to claim 5, further comprising:
means for taking the elevator car out of use after stopping at the selected next possible floor.

9. A non-transitory computer readable medium comprising a computer program comprising instructions which, when the program is executed by at least one processor, cause an apparatus to perform the method of claim 1.

10. A non-transitory computer-readable medium comprising a computer program comprising instructions which, when the program is executed by at least one processor, cause an apparatus to perform the method of claim 2.

11. The method according to claim 2, further comprising:
taking the elevator car out of use after stopping at the selected next possible floor.

12. The method according to claim 3, further comprising:
taking the elevator car out of use after stopping at the selected next possible floor.

13. The elevator system according to claim 6, further comprising:
means for allowing the elevator car to pass at least one locked floor before stopping at the next possible floor.

14. The elevator system according to claim 6, further comprising:
means for taking the elevator car out of use after stopping at the selected next possible floor.

15. The elevator system according to claim 7, further comprising:
means for taking the elevator car out of use after stopping at the selected next possible floor.

16. A non-transitory computer readable medium storing a computer program comprising instructions which, when the program is executed by at least one processor, cause an apparatus to perform the method of claim 3.

17. A non-transitory computer readable medium storing a computer program comprising instructions which, when the program is executed by at least one processor, cause an apparatus to perform the method of claim 4.
